(19) United States
(12) Patent Application Publication
(10) Pub. No.: US 2015/0089809 A1
(43) Pub. Date: Apr. 2, 2015

(54) SCALING TO CUSTOM-SIZED TURBOMACHINE AIRFOIL METHOD

(71) Applicant: General Electric Company, Schenectady, NY (US)

(72) Inventors: Tao Guo, Niskayuna, NY (US); Michael Ernest Boisclair, Glenville, NY (US); Joseph Anthony Cotroneo, Clifton Park, NY (US); Carl Douglas Hofer, Clifton Park, NY (US); Amir Mujezinovic, Saratoga Springs, NY (US); Vsevolod Yuriyevich Ostrovskiy, Clifton Park, NY (US)

(73) Assignee: General Electric Company, Schenectady, NY (US)

(21) Appl. No.: 14/039,588

(22) Filed: Sep. 27, 2013

(51) Int. Cl. B23P 15/02; F01D 5/14

(52) U.S. Cl. CPC B23P 15/02; F01D 5/14
USPC 29/889.7

(57) ABSTRACT

A method of engineering a turbomachine airfoil may include providing a master airfoil configuration having a preset outer and inner radius relative to an axis of rotation thereof. The master airfoil configuration may be radially scaled to a custom-sized turbomachine airfoil having an outer radius different than the preset outer radius of the master airfoil configuration, and/or an inner radius different than the preset inner radius of the master airfoil configuration. Tuning a frequency of the custom-sized turbomachine airfoil by changing a parameter of at least one of a part span shroud and a tip shroud may then be performed. Axial scaling may also be performed. The custom-sized turbomachine airfoil may be employed in the turbomachine without performing wheel box testing, and may exhibit substantially similar operational characteristics as the master airfoil configuration.

### BACKGROUND OF THE INVENTION

1. Technical Field

The disclosure is related generally to turbomachine airfoils. More particularly, the disclosure is related to a method of scaling a turbomachine airfoil in such a way as to reduce the need for further aerodynamic testing and mechanical testing such as wheel box testing.

2. Related Art

Conventional turbomachines are frequently utilized to convert power. For example, in a steam turbine system, steam is forced across sets of steam turbine blades, which are coupled to the rotor of the steam turbine system. The force of the steam on the blades causes those blades (and the coupled body of the rotor) to rotate. In some cases, the rotor is coupled to the drive shaft of a dynamoelectric machine such as an electric generator. Other turbomachines such as jet engines, compressors, etc., work on similar concepts.

The rotor of a turbomachine typically includes a plurality of stages of rotating blades and a plurality of corresponding stationary vanes positioned axially adjacent each set of the plurality of rotating blades. More specifically, each stage may include a circumferential arrangement of blades positioned around the rotor and a row of corresponding vanes positioned axially adjacent the blades. The operational efficiency of the turbomachine is dependent, at least in part, on the configuration of the respective stages of blades and/or the corresponding vanes. For a turbine, the rotating blades are commonly referred to as buckets and the stationary vanes as nozzles. For example, in a low-pressure (LP) steam turbine system, an operational efficiency may be dependent on the configuration of the buckets and corresponding nozzles and, in particular, a last stage bucket (LSB). As such, each stage of the plurality of buckets and the corresponding nozzles may be engineered in consideration of a number of aerodynamic and/or mechanical factors (e.g., steam pressure and temperature, flow rate, blade height, blade weight, etc.) to ensure reliability and optimum operational efficiency.

The process of engineering, manufacturing, testing and tuning the stages of buckets and nozzles for use in the operation of the turbomachine can be expensive and time consuming. In view of this fact, manufacturers often engineer a preset number of radial sizes of a particular bucket and/or nozzle of the turbomachine to manufacture and sell, and a customer is limited to employing one of those pre-selected sizes. For example, a manufacturer may decide to manufacture three radial sizes of an LSB for an LP steam turbine section of a steam turbine system, or two radial sizes of particular blade/vane stage of a compressor. Once engineered by a manufacturer, each of the preset number of radial sizes may have their stages of the plurality of buckets and corresponding nozzles tested to ensure proper and safe operation and to provide maximum operational efficiency for the turbomachine. For example, buckets/nozzles may be tested and tuned to avoid frequency-based disturbances.

Where an optimal size of the turbomachine necessary to accommodate the customer's unique system does not match one of the preset radial sizes, the customer must choose a preset size that is either smaller or larger than is optimal. Consequently, performance and/or efficiency is lost. More specifically, since the other stages of the particular turbomachine are engineered around the chosen size of bucket and/or nozzle to accommodate the customer's other requirements, performance and efficiency optimization is very difficult. Customization of the preset radial sizes is typically not an option due to the need to repeat testing, some of which is referred to as ‘wheel box testing’, of the bucket, which is costly and very time consuming.

### BRIEF DESCRIPTION OF THE INVENTION

A first aspect of the invention includes a method of engineering a turbomachine airfoil, the method comprising: providing a master airfoil configuration having a preset outer radius and a preset inner radius relative to an axis of rotation thereof; and radially scaling the master airfoil configuration to a custom-sized turbomachine airfoil having at least one of: an outer radius different than the preset outer radius of the master airfoil configuration and an inner radius different than the preset inner radius of the master airfoil configuration.

A second aspect of the invention includes a method of engineering a turbomachine airfoil, the method comprising: providing a master airfoil configuration having a preset outer radius and a preset inner radius relative to an axis of rotation thereof; radially scaling the master airfoil configuration to a custom-sized turbomachine airfoil having at least one of: an outer radius different than the preset outer radius of the master airfoil configuration and an inner radius different than the preset inner radius of the master airfoil configuration; axially scaling the master airfoil configuration to the custom-sized turbomachine airfoil while maintaining a pitch-to-axial width ratio from the master airfoil configuration in the custom-sized turbomachine airfoil; tuning a frequency of the custom-sized turbomachine airfoil by changing a parameter of at least one of a part span shroud and a tip shroud; and employing the custom-sized turbomachine airfoil in the turbomachine without performing wheel box testing, wherein the master airfoil configuration has known operational characteristics and the custom-sized turbomachine has substantially similar operational characteristics.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a front perspective view of a master airfoil configuration of an illustrative bucket and/or nozzle according to embodiments of the invention.

FIG. 2 shows a front perspective view of a smaller custom-sized turbomachine airfoil configuration based on the master airfoil configuration of FIG. 1 according to embodiments of the invention.

FIG. 3 shows a front perspective view of a larger custom-sized turbomachine airfoil configuration based on the master airfoil configuration of FIG. 1 according to embodiments of the invention.

FIG. 4 shows a side perspective view of a master airfoil configuration of an illustrative bucket and/or nozzle according to embodiments of the invention.

FIG. 5 shows a side perspective view of a smaller custom-sized turbomachine airfoil configuration based on the master airfoil configuration of FIG. 4 according to embodiments of the invention.

FIG. 6 shows a side perspective view of a larger custom-sized turbomachine airfoil configuration based on the master airfoil configuration of FIG. 4 according to embodiments of the invention.

FIG. 7 shows a perspective view of a number of custom-sized turbomachine airfoils according to embodiments of the invention.

FIG. 8 shows a cross-sectional view of custom-sized turbomachine airfoil configurations in different stages of a turbomachine based on a single master airfoil configuration according to embodiments of the invention.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As discussed herein, aspects of the invention relate generally to a method of engineering a turbomachine airfoil. Aspects of the present invention are applicable across all varieties of turbomachines such as but not limited to: a low pressure (LP) steam turbine section, a high pressure (HP) steam turbine section, an intermediate pressure (IP) steam turbine section, a compressor, a jet engine, etc. In terms of an LP steam turbine section, teachings of the present invention may find special applicability to a last stage bucket or nozzle of the LP steam turbine section. As the operations and functions of each of these forms of turbomachines are well known, no detail of their particular functions and components is presented for brevity. As used herein, the term “airfoil” includes buckets or nozzles or blades or vanes within a turbomachine, e.g., a custom-sized turbomachine airfoil may include a low pressure steam turbine bucket, a low pressure steam turbine nozzle, a compressor vane, a compressor blade, etc.

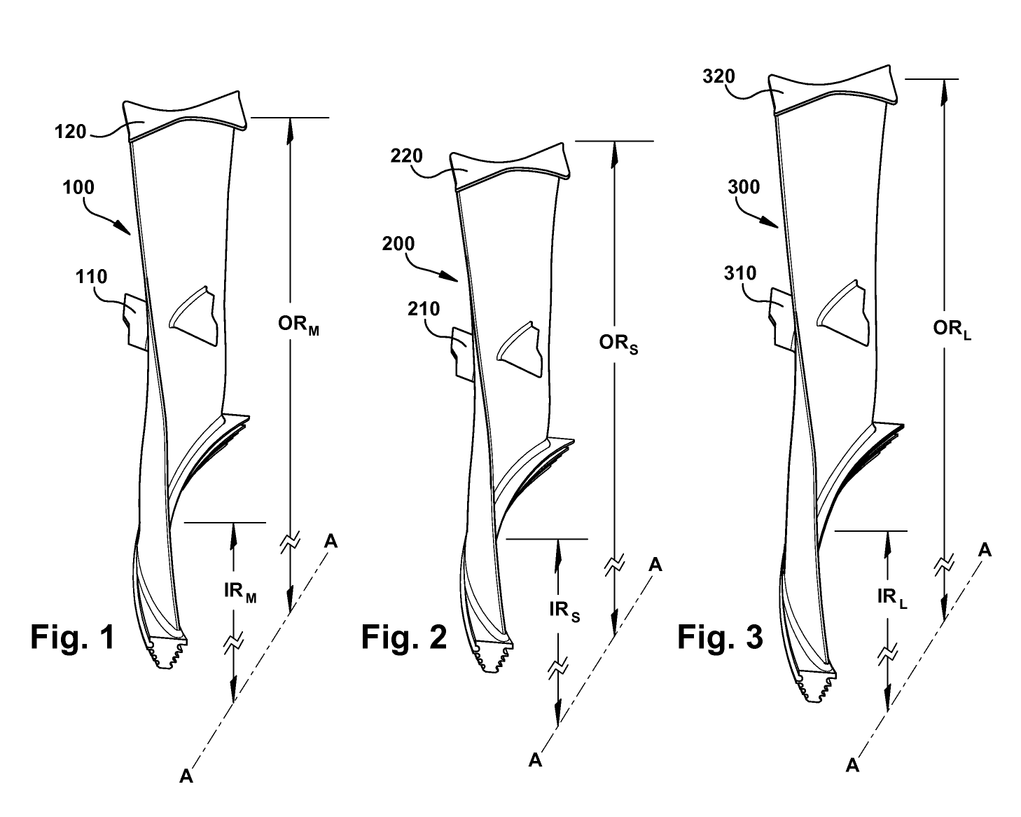

Turning to FIG. 1, a method according to embodiments of the invention may include providing a master airfoil configuration 100 having a preset geometrical shape and size including a preset outer radius OR_{M} relative to an axis of rotation thereof and a preset inner radius IR_{M}. It is understood that the axis of rotation would be that of a rotor, not shown but denoted by axis of rotation A, to which an airfoil is coupled in a turbomachine. As used herein, the terms “radial” and/or “radially” refer to the relative position/direction of objects along a radius which is substantially perpendicular with an axis of rotation A of a rotor to which an airfoil is coupled. (Note, axis of rotation A is shown in phantom to denote that the rotor and the actual axis of rotation is not shown due to drawing limitations. It is understood that airfoils 100, 200, 300 are coupled to a rotor using conventional rotor wheels.). Outer radius as used herein is a distance from axis of rotation A to an outer extent of a tip section, i.e., location at which airfoil ends extending to a tip shroud 120, and inner radius as used herein is a distance from axis of rotation A to a root section, i.e., location at which airfoil begins extending from the connection to the rotor.

Master airfoil configuration 100 may take any of a variety of forms now known or later developed in the turbomachine industry for representing an ideal, foundational airfoil. Master airfoil 100 has been tested and/or modeled such that operational characteristics are known. The testing may include any now known or later developed tests such as aeromechanics, flow volume, dimension tolerance, frequency tuning, aerodynamic performance, etc. In particular, certain tests referred to as ‘wheel box testing’ to ensure proper frequency tuning may be employed. Wheel box testing may include, for example, mounting an airfoil having strain gauges thereon on a rotor and turning it at operational speeds, usually with an air jet impinging on the rotating airfoil, to determine natural frequencies. Other forms of wheel box testing may also be employed. The tests may be carried out on any and all stages of development: models, prototypes and/or production, etc. The operational characteristics may include but are not limited to: flow volume under various loads, stress under various loads, frequency, expected expansion/contraction under various loads, etc. In any event, master airfoil configuration 100 represents an ideal airfoil from which other airfoils may be sectioned or modeled. Master airfoil configuration 100 is also sized with a large enough radius ratio (outer radius divided by inner radius) to accommodate a plurality of outer radii for a plurality of different sized applications, i.e., of the particular turbomachine to which it is applicable. That is, it is configured to allow sectioning and/or scaling to a large range of different sized applications. Further, master airfoil configuration 100 may be used to create airfoils for a number of stages within a particular turbomachine.

In one embodiment, master airfoil configuration 100 may include a part span shroud 110 for mating with a part span shroud of a circumferentially adjacent airfoil of substantially identical configuration in a known fashion. Part span shrouds 110 are well known within the art for providing stability where required, e.g., in a last stage bucket of a low pressure steam turbine section. Part span shroud 110 may also be radially positioned to tune a frequency of a turbomachine airfoil, as will be described in greater detail herein. In addition, in an embodiment, master airfoil configuration 100 may include a tip shroud 120 at an outer radial extent thereof. Tip shrouds 120 are well known within the art for providing stability where required, e.g., in a last stage bucket of a low pressure steam turbine section. As known in the art, tip shroud 120 may mate with an identical tip shroud of a circumferentially adjacent airfoil of substantially identical configuration in a known fashion. A mass and/or volume of tip shroud 120 may be modified to assist in frequency tuning of a turbomachine airfoil, as will be described in greater detail herein.

Referring to FIGS. 2 and 3, the method according to embodiments of the invention may also include radially scaling master airfoil configuration 100 to a custom-sized turbomachine airfoil 200 or 300 having at least one of: an outer radius (OR_{S}, OR_{L}, respectively) different than the preset outer radius OR_{M} (FIG. 1) of master airfoil configuration 100, and an inner radius (IR_{S}, IR_{L}, respectively) different than the preset inner radius IR_{M} (FIG. 1) of master airfoil configuration 100. FIG. 2 shows a custom-sized turbomachine airfoil 200 that has been scaled to be radially shorter than master airfoil configuration 100 at an outer radius (i.e., OR_{S}<OR_{M}), and FIG. 3 shows a custom-sized turbomachine airfoil 300 that has been radially scaled to be longer than master airfoil configuration 100 at an outer radius (i.e., OR_{L}>OR_{M}). Although difficult to illustrate, in FIG. 2, custom-sized turbomachine airfoil 200 has also been scaled to be shorter than master airfoil configuration 100 at an inner radius (i.e., IR_{S}<IR_{M}). Similarly, in FIG. 3, custom-sized turbomachine airfoil 300 has been radially scaled to be longer than master airfoil configuration 100 at a larger inner radius (i.e., IR_{L}>IR_{M}). It is understood that the outer and inner radii do not need to be scaled in the same direction, i.e., one may be smaller than the respective radius of the master and the other larger.

The radial scaling may be carried out using any now known or later developed technique. Radial scaling acts to either shorten or lengthen master airfoil configuration 100 in a direction generally perpendicular to its respective rotor. It is understood that radial scaling results in an airfoil that, while aerodynamically similar to the master airfoil with customized length, can exhibit unacceptable frequency margins.

In accordance with embodiments of the invention and in contrast to conventional airfoil configuration, the method may also include the afore-mentioned radial scaling with tuning a frequency of custom-sized turbomachine airfoil 200, 300 by changing a parameter of at least one of a part span shroud 210, 310 (FIGS. 2-3, respectively) and a tip shroud 220, 320 (FIGS. 2-3, respectively). The frequency tuning is to ensure operation of custom-sized turbomachine airfoil 200, 300 avoids a natural frequency thereof and thus prevents instability and potential destruction during operation. In one embodiment, the parameter of the part span shroud 210, 310 may include a radial position thereof. For example, part span shroud 210 may be moved radially outward or inwardly relative to the radial position of part span shroud 110 of master airfoil configuration 100 (or the position thereof created by radially scaling master airfoil configuration 100) to tune custom-sized turbomachine airfoil 200. Modifications of other parameters of part span shroud 210, 310, e.g., weight, rotational position relative to airfoil 200, 300, connection mechanism, etc., may also be possible. In one embodiment, the parameter of tip shroud 220, 320 (FIGS. 2-3, respectively) that may be changed includes a weight (i.e., mass) thereof. For example, tip shroud 320 may have less mass than tip shroud 120 of master airfoil configuration 100. Modifications of other parameters of tip shroud 220, 320, e.g., shape, rotational position relative to airfoil 200, 300, etc., may also be possible. It is understood where one of the part span shroud and the tip shroud are not provided on the airfoil, only the other one that is provided may be modified.

The custom-sized turbomachine airfoil configuration methodology described herein provides custom-sized turbomachine 200, 300 having substantially similar operational characteristics as master airfoil configuration 100. Consequently, the need for further testing such as wheel box testing is reduced and/or eliminated, allowing turbomachine manufacturers to provide custom-sized turbomachine airfoils 200, 300 without the additional engineering costs and time constraints currently unavoidable in the field. Thus, the method may further include employing custom-sized turbomachine airfoil 200, 300 in the turbomachine without performing wheel box testing.

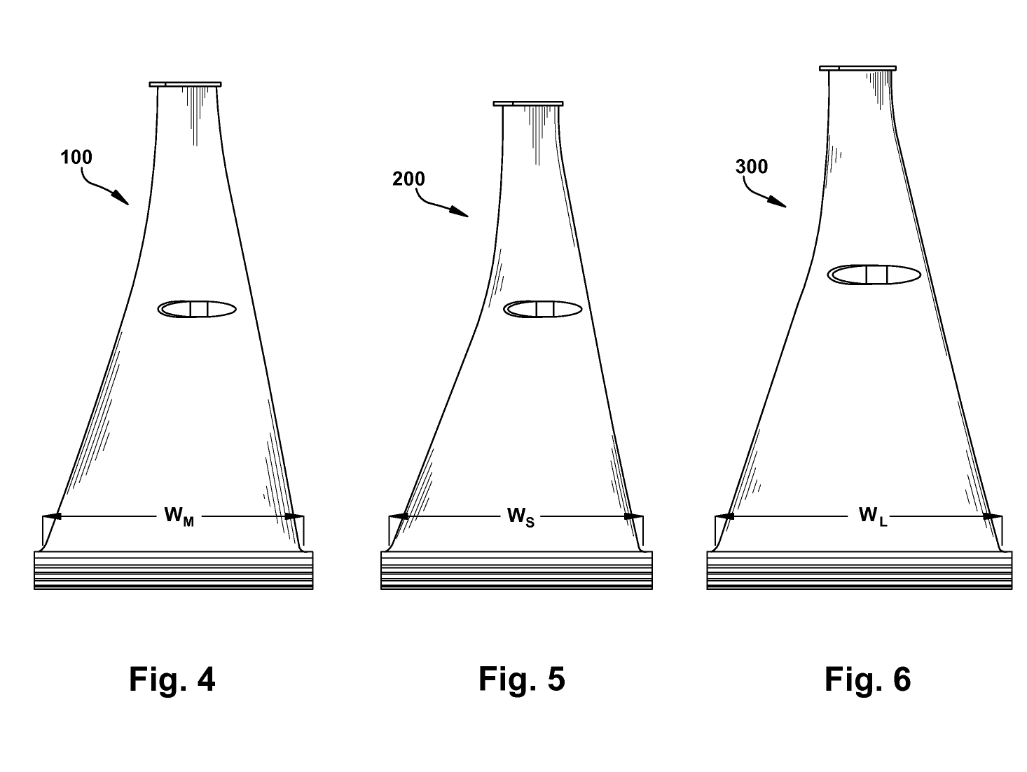

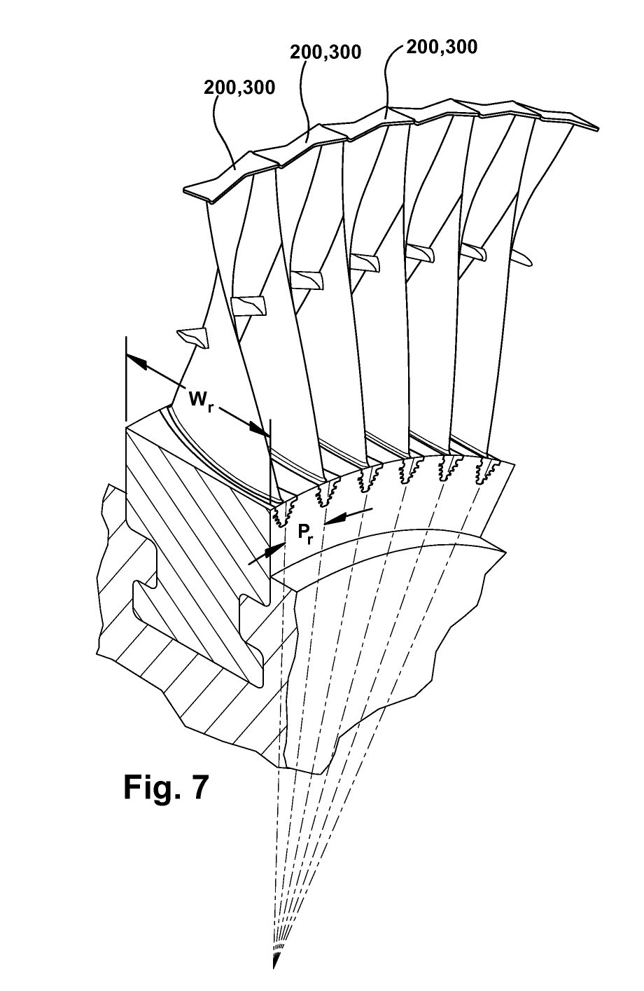

In an alternative embodiment, the method may further include axially scaling master airfoil configuration 100 to custom-sized turbomachine airfoil 200, 300. Axially scaling in this setting is performed while maintaining a pitch-to-axial width ratio from master airfoil configuration 100 in custom-sized turbomachine airfoil 200, 300. As used herein, the terms “axial” and/or “axially” refer to the relative position/direction of objects along a rotational axis of a rotor to which the airfoil is coupled. In FIGS. 4-7, axial widths W_{M}, W_{S}, W_{L}, Wᵣ at a particular radius (e.g., a root radius, near coupling to rotor as shown), respectively, is illustrated for purposes of describing the axial scaling. It is emphasized, however, that axial scaling occurs at all cross-sections of custom-sized turbomachine airfoil 200, 300, e.g., tip, pitch radius (half way along length), root and any points in between. Referring to FIG. 7, as used herein, “pitch” P indicates a circumferential spacing between airfoils 200, 300, and “axial width” Wᵣ indicates a length parallel to an axis of rotation of a rotor of the turbomachine at a particular cross-section. In one example, for a radial position of a stage of airfoils that is constant (i.e., root radial position does not change), if the width of the airfoils within the stage are halved, the number of airfoils for the stage would double to provide enough airfoils to fill the circumference about the rotor and maintain the same pitch-to-axial width as the master airfoil configuration. For example, if a master airfoil configuration 100 had an axial width for the root airfoil W_{M} (FIG. 4) of 10 centimeters and a pitch Pr (FIG. 7) thereof was 5 centimeters, the pitch-to-axial width ratio would be 0.5. Consequently, in a custom-sized turbomachine airfoil, e.g., airfoil 200 in FIG. 5, in which the root airfoil axial width W_{S} is 5 centimeters, a pitch (Pr)(FIG. 7) thereof would be 2.5 cm, resulting in the need to double the number of airfoils 200 to fill the circumference at the selected root radius. Similar calculations could be performed for any of a number of cross sections of custom-sized turbomachine airfoils 200, 300. Axial scaling may be used to control bending stress and/or frequency tuning and may be used independently of radial scaling.

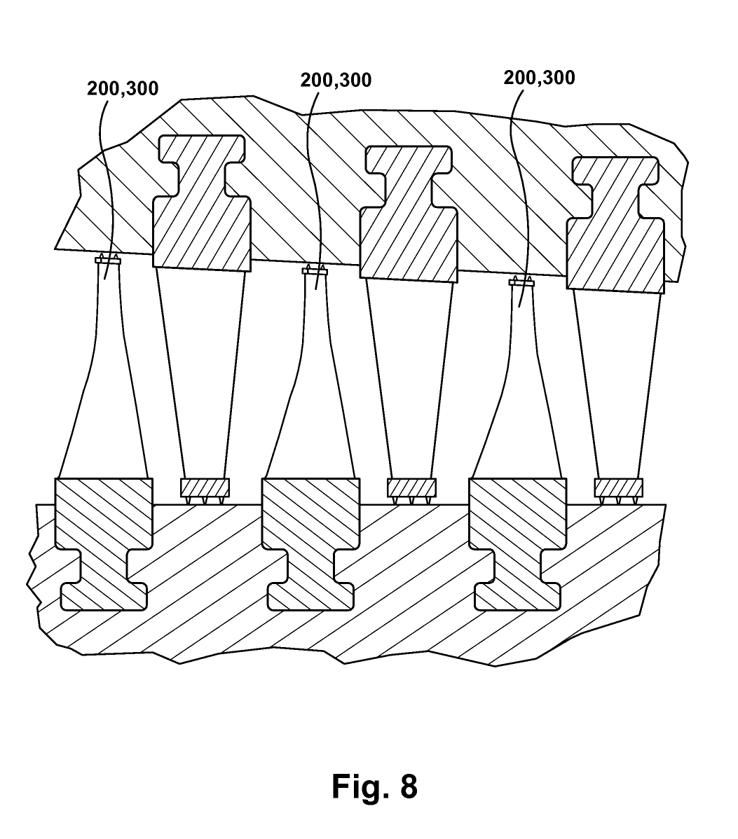

As shown in FIG. 8, it is understood that the method described herein can be applied for different stages within the same turbomachine and/or section of the turbomachine using the same master airfoil configuration for each stage. In this fashion, the same master airfoil configuration can be used to create custom-sized turbomachine airfoils having substantially similar operational characteristics for a variety of different sized applications without the additional expense and time of the conventionally necessary tests.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of engineering a turbomachine airfoil, the method comprising:
providing a master airfoil configuration having a preset outer radius and a preset inner radius relative to an axis of rotation thereof; and
radially scaling the master airfoil configuration to a custom-sized turbomachine airfoil having at least one of: an outer radius different than the preset outer radius of the master airfoil configuration and an inner radius different than the preset inner radius of the master airfoil configuration.

2. The method of claim 1, wherein the master airfoil configuration has known operational characteristics and the custom-sized turbomachine has substantially similar operational characteristics.

3. The method of claim 1, further comprising tuning a frequency of the custom-sized turbomachine airfoil by changing a parameter of at least one of a part span shroud and a tip shroud.

4. The method of claim 3, wherein the parameter of the part span shroud includes a radial position thereof.

5. The method of claim 3, wherein the parameter of the tip shroud includes a weight thereof.

6. The method of claim 5, further comprising axially scaling the master airfoil configuration to the custom-sized turbomachine airfoil while maintaining a pitch -to-axial width ratio from the master airfoil configuration in the custom-sized turbomachine airfoil.

7. The method of claim 1, further comprising axially scaling the master airfoil configuration to the custom-sized turbomachine airfoil while maintaining a pitch-to-axial width ratio from the master airfoil configuration in the custom-sized turbomachine airfoil.

8. The method of claim 1, wherein the turbomachine is a low pressure (LP) steam turbine section.

9. The method of claim 8, wherein the custom-sized turbomachine airfoil is a last stage bucket of the LP steam turbine section.

10. The method of claim 1, wherein the custom-sized turbomachine airfoil is chosen from the group consisting of: a low pressure steam turbine bucket, a low pressure steam turbine nozzle, a compressor blade and a compressor vane.

11. The method of claim 1, wherein the custom-sized turbomachine airfoil includes at least one of a turbine bucket and a turbine nozzle.

12. The method of claim 1, wherein the master airfoil configuration accommodates a plurality of outer radii for a plurality of different sized applications.

13. The method of claim 1, further comprising employing the custom-sized turbomachine airfoil in the turbomachine without performing wheel box testing.

14. A method of engineering a turbomachine airfoil, the method comprising:
providing a master airfoil configuration having a preset outer radius and a preset inner radius relative to an axis of rotation thereof;
radially scaling the master airfoil configuration to a custom-sized turbomachine airfoil having at least one of: an outer radius different than the preset outer radius of the master airfoil configuration and an inner radius different than the preset inner radius of the master airfoil configuration;
axially scaling the master airfoil configuration to the custom-sized turbomachine airfoil while maintaining a pitch -to-axial width ratio from the master airfoil configuration in the custom-sized turbomachine airfoil;
tuning a frequency of the custom-sized turbomachine airfoil by changing a parameter of at least one of a part span shroud and a tip shroud; and
employing the custom-sized turbomachine airfoil in the turbomachine without performing wheel box testing,
wherein the master airfoil configuration has known operational characteristics and the custom-sized turbomachine has substantially similar operational characteristics.

15. The method of claim 14, wherein the parameter of the part span shroud includes a radial position thereof.

16. The method of claim 14, wherein the parameter of the tip shroud includes a weight thereof.

17. The method of claim 14, wherein the turbomachine is a low pressure (LP) steam turbine section.

18. The method of claim 17, wherein the custom-sized turbomachine airfoil is a last stage bucket of the LP steam turbine section.

19. The method of claim 14, wherein the custom-sized turbomachine airfoil includes at least one of a turbine bucket and a turbine nozzle.

20. The method of claim 14, wherein the master airfoil configuration accommodates a plurality of outer radii for a plurality of different sized applications.
